(19) United States
(12) Patent Application Publication
(10) Pub. No.: US 2002/0003507 A1
(43) Pub. Date: Jan. 10, 2002

(54) DUAL MODE DIGITAL VIDEO INTERFACE AND REMOTE LCD MONITOR

(76) Inventor: ROBERT D. DODGE, CEDAR RAPIDS, IA (US)

Correspondence Address: LAURA M. SLENZAK, SIEMENS CORPORATION, 186 WOOD AVENUE SOUTH, ISELIN, NJ, 08830, US

(21) Appl. No.: 09/258,488

(22) Filed: Feb. 26, 1999

(51) Int. Cl. G09G 5/00

(52) U.S. Cl. 345/3.1

(57) ABSTRACT

A dual mode digital video interface for a computer system is disclosed. A video controller generates a video signal to be displayed on the flat panel display. A first interface couples the video controller to the flat panel display in a first display mode when the flat panel display is a first type of display, and a second interface couples the video controller to the flat panel display in a second display mode when the flat panel display is a second type of display. The first interface is enabled when the first type of display is coupled to the computer system, and the second interface is enabled when the second type of display is coupled to the computer system. The dual mode digital video interface may be implemented in a navigation system for a transit vehicle having a computer system for controlling the navigation of the transit vehicle, a global positioning system (GPS) receiver, and a display for displaying positioning and timing information of the transit vehicle received by the GPS receiver. The dual mode digital video interface allows the display to be two or more types of displays.

### BACKGROUND OF THE INVENTION

Traditionally, video interfaces for display monitors have been based upon analog circuit technology. However, the advent of higher performance digital systems at lower costs allows for the utilization of digital video interfaces. Newer digital video standards have been promulgated by organizations such as the Video Electronics Standards Association (VESA) which specifies a digital interface that provides higher performance, lower cost and support of placing the monitor at greater distances away from a video source such as a computer system. VESA is a standards organization comprised of leading computer, flat panel display, cabling, connector and integrated circuit manufacturers. Digital video interfaces allow computer controlled display systems to be installed in locations and applications where previous systems were too large and too costly for a given performance level to be of any practical value.

One ideal application of a digital interface video system is in transit systems where a computer system coupled to a location database in conjunction with a coordinate positioning and time reference system provides accurate navigation and scheduling information. For example, such a transit system may be utilized in a city busing system wherein the driver of a bus is provided with information on navigating the bus along a predetermined route and whether or not the driver is on an expected schedule. In another example, the transit system may be utilized in an airport parking shuttle service wherein the coordinate locations of customers' vehicles in a large parking facility are stored in the transit system such that the driver of the shuttle may drive each customer to the exact location of the customer's vehicle based upon navigation with the transit system. Often, the performance and budget constraints of both applications may vary such that a first application may only require a lower performance, lower cost display system whereas a second application may require a higher performance, higher cost display system. The display interface of the transit system ideally would be able to utilize the appropriate display system. However, standards organizations typically specify the latest, highest performance interface standards without regard or consideration to lower performance applications, requiring the design of the transit system to add circuitry in addition to the higher performance interface in order to accommodate a lower cost display system thereby mitigating against the goal of providing a lower cost system. Thus, there lies a need to provide a video display interface that is capable of accommodating at least two types displays without prohibitively increasing the cost or complexity of the display interface.

### SUMMARY OF THE INVENTION

The present invention is directed to a dual mode digital video interface for coupling a flat panel display to a computer system. In one embodiment, the dual mode digital video interface includes a video controller, disposed in the computer system, for generating a video signal to be displayed on the flat panel display, a first interface for operatively coupling the video controller to the flat panel display in a first display mode when the flat panel display is a first type of display, and a second interface for operatively coupling the video controller to the flat panel display in a second display mode when the flat panel display is a second type of display, the first interface being enabled when the first type of display is coupled to the computer system and the second interface being enabled when the second type of display is coupled to the computer system.

The present invention is further directed to a navigation system for a transit vehicle. In one embodiment, the navigation system includes a computer system, disposed in the transit vehicle, for controlling the navigation of the transit vehicle, a global positioning system receiver, coupled to the computer system, for receiving a positioning and timing reference from a constellation of space vehicles in a global positioning system, a display, coupled to the computer system, for displaying positioning and timing information of the transit vehicle, and a dual mode digital video interface, operatively disposed in the computer system, for providing a first digital interface in a first mode for controlling the display when the display is a first type of display, and for providing a second digital interface in a second mode for controlling the display when said display is a second type of display.

It is to be understood that both the foregoing general description and the following detailed description are exemplary and explanatory only and are not restrictive of the invention as claimed.

The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram of the hardware of a computer system operable to tangibly embody the present invention;

FIG. 2 is a block diagram of a dual mode digital video interface in accordance with the present invention;

FIG. 3A is a block diagram of the dual mode digital video interface of FIG. 2 further showing a simple differential interface for coupling to a monochrome LCD and a VESA interface for coupling to a color LCD;

FIGS. 3B and 3C are schematic diagrams of the simple differential interfaces shown in FIG. 3A; and

FIG. 4 is a block diagram of a transit system ideally suitable for utilizing the dual mode digital video interface of the present invention.

### DETAILED DESCRIPTION OF THE INVENTION

Reference will now be made in detail to the presently preferred embodiment of the invention, an example of which is illustrated in the accompanying drawings.

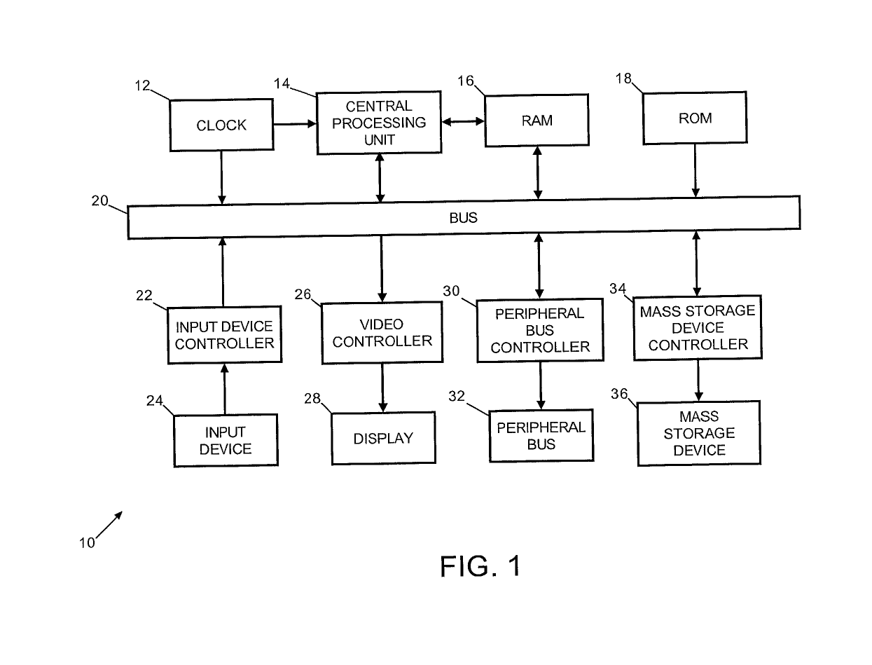

Referring now to FIG. 1, a computer system operable to tangibly embody a dual mode digital video interface in accordance with the present invention will be discussed. The computer system 10 generally comprises a central bus 20 for transferring data among the components of computer system 10. A clock 12 provides a timing reference signal to the components of computer system 10 via bus 20 and to a central processing unit 14. The central processing unit 14 is utilized for interpreting and executing instructions and for performing calculations for computer system 10. A random access memory (RAM) device 16 couples to bus 20 and to central processing unit 14 for operating as memory for central processing unit 14 and for other devices coupled to bus 20. A read-only memory device (ROM) 18 is coupled to the components of computer system 10 via bus 20 for operating as memory for storing instructions or data that are normally intended to be read but not to be altered except under specific circumstances (e.g., when the instructions or data are desired to be updated). ROM device 18 typically stores instructions for performing basic input and output functions for computer system 10 and for loading an operating system into RAM device 16.

An input device controller 22 is coupled to bus 20 for allowing an input device 24 to provide input signals into computer system 10. Input device 24 may be a keyboard, mouse, joystick, trackpad or trackball, microphone, modem, or a similar input device. Further, input device 24 may be a graphical or tactile input device such as a touch pad for inputting data with a finger or a stylus. Such a graphical or tactile input device 24 may be overlaid upon a screen of a display device 28 for correlating the coordinates of a tactile input with information displayed on display 28. Display 28 is controlled by a video controller 26 that provides a video signal received via bus 20 to display 28. Display 28 may be any type of display or monitor suitable for displaying information generated by computer system 10 such as cathode ray tube (CRT), a liquid crystal display (LCD), gas or plasma display, or a field emission display panel. Preferably, display 28 is a flat-panel display having a depth being shallower than its width. A peripheral bus controller 30 couples peripheral devices to central bus 20 of computer system 10 via a peripheral bus 32. Peripheral bus 32 is preferably in compliance with a standard bus architecture such as an Electrical Industries Association Recommended Standard 232 (RS-232) standard, an Institute of Electrical and Electronics Engineers (IEEE) 1394 serial bus standard, a Peripheral Component Interconnect (PCI) standard, or a Universal Serial Bus (USB) standard, etc. A mass storage device controller 34 controls a mass storage device 36 for storing large quantities of data or information, such as a quantity of information larger than the capacity of RAM device 16. Mass storage device 36 is typically non-volatile memory and may be a disk drive such as a hard disk drive, floppy disk drive, optical disk drive, floptical disk drive, etc.

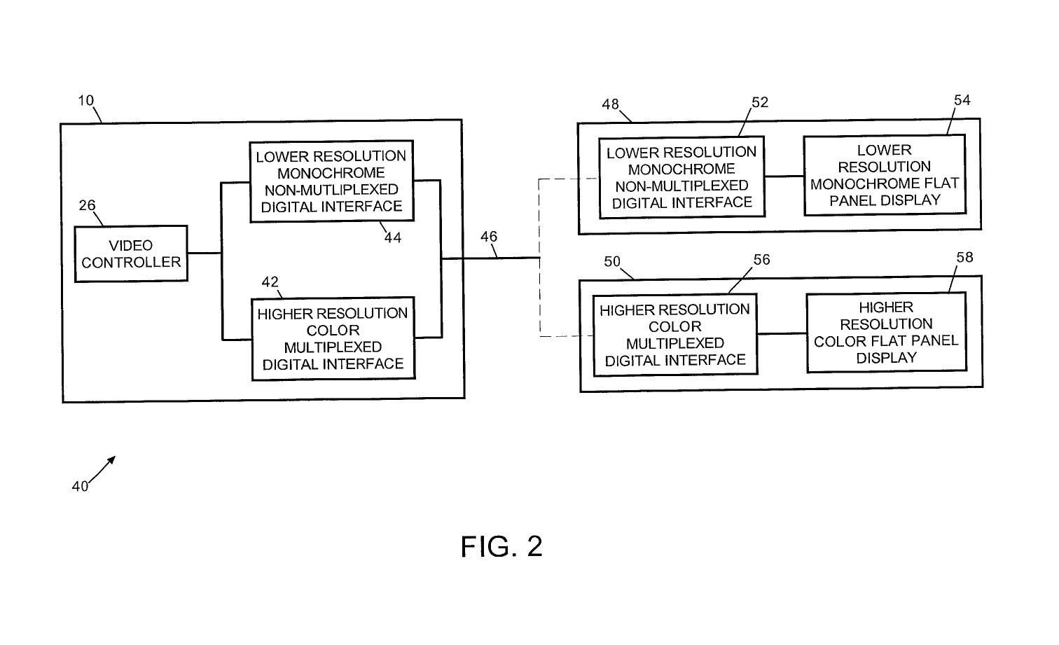

Referring now to FIG. 2, a block diagram of a dual mode digital video interface in accordance with the present invention will be discussed. The dual mode digital interface system 40 may be tangibly embodied by computer system 10 discussed with respect to FIG. 1. Video controller 26 provides a video output signal for ultimately controlling and driving one or more display monitors 48 or 50. For example, monitor 48 may include a lower resolution, monochrome, flat panel display 54 while monitor 50 may include a higher resolution, color, flat panel display 58. Video controller 26 provides an output signal to the input of a higher resolution, color, multiplexed digital video interface 42 and to the input of a lower resolution, monochrome, non-multiplexed digital video interface 44 of computer system 10. The outputs of interfaces 42 and 44 are transmitted over an interconnect cabling 46 that preferably comprises four twisted wire-pairs. Interconnect cabling 46 is designed to allow runs on the order of ten meters such that a monitor 48 or 50 may be disposed in a position on the order of ten meters away from the location of computer system 10. Interfaces 42 and 44 preferably utilize low voltage differential signaling such that the power flowing through interconnect cabling 46 is kept low to minimize electromagnetic interference (EMI). Interfaces 42 and 44 include a tri-state driver controller for enabling either one or the other interface depending upon the type of display utilized and coupled to computer system 10. Monitor 48 likewise includes a lower resolution, monochrome, non-multiplexed digital interface for coupling with interface 44 to drive display 54 when monitor 48 is coupled to computer system 10, and monitor 50 includes a higher resolution, color, multiplexed, digital interface for coupling with interface 42 when monitor is coupled with computer system 10.

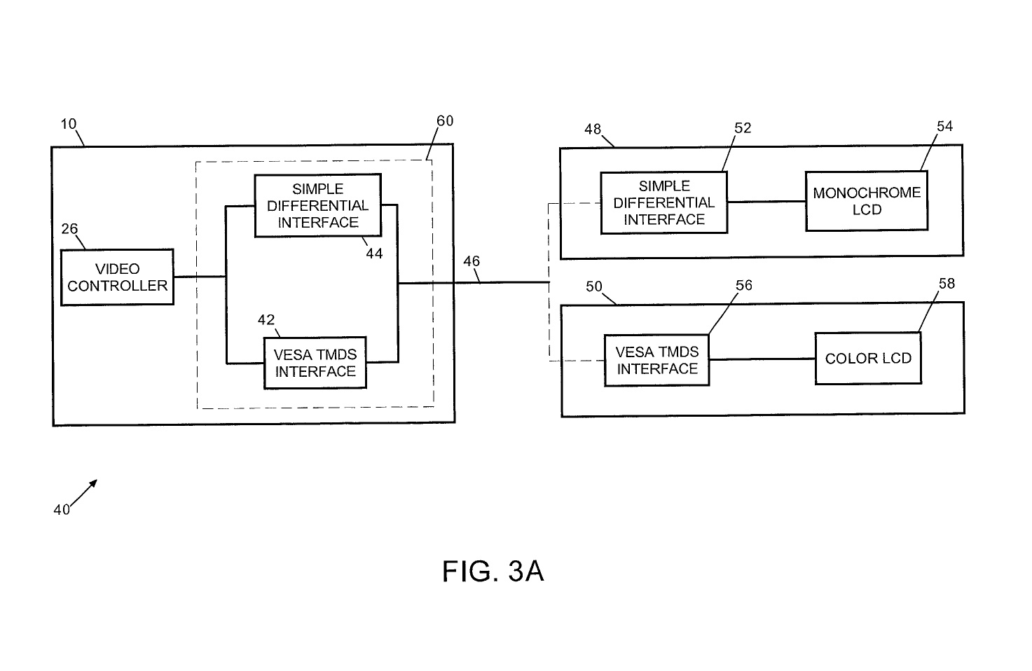

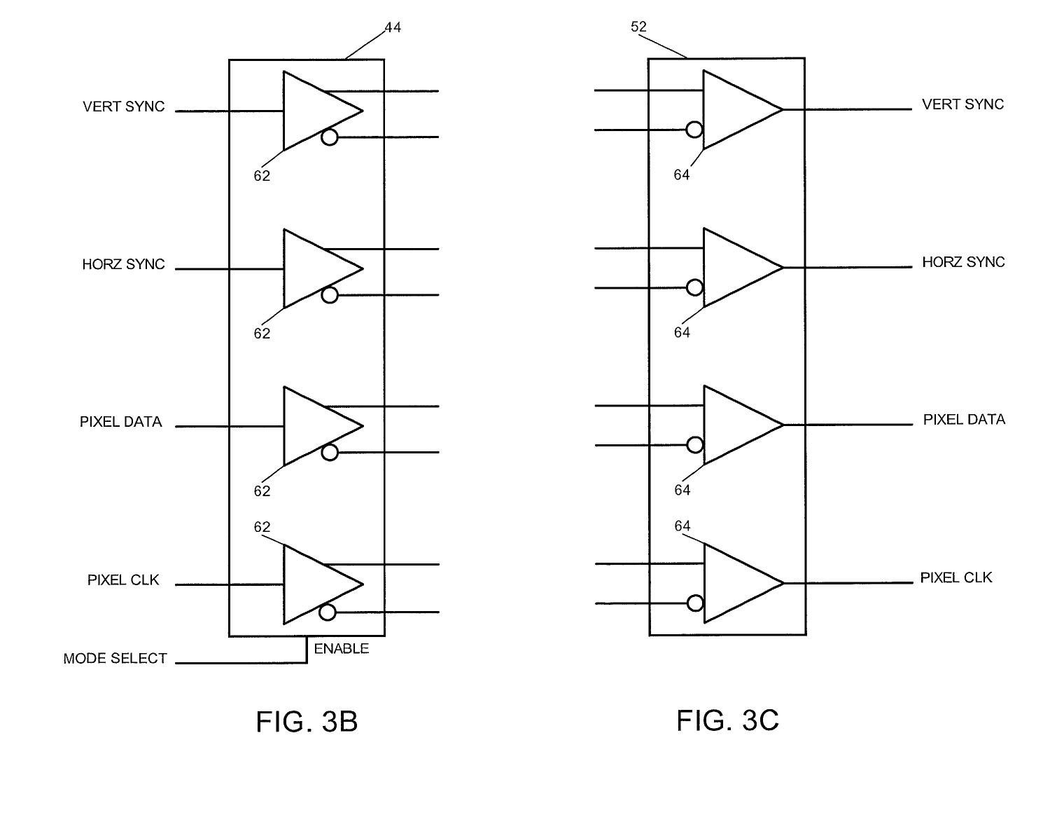

Referring now to FIG. 3A, a block diagram of the dual mode digital video interface of FIG. 2 further showing a simple differential interface for coupling to a monochrome LCD and a VESA interface for coupling to a color LCD will be discussed. Video controller 26 provides an output signal to both a VESA compliant interface 42 and to a simple differential interface 44. Interfaces 42 and 44 may be preferably implemented on a single integrated circuit 60 in order to provide a simple, lower cost video display interface capable of operating in one or two modes based upon the type of monitor to be utilized. Monitor 48 likewise includes a simple differential interface 52 for coupling with interface 44 to provide an output signal to monochrome LCD display 54, and monitor 50 includes a VESA compliant interface 56 for coupling with interface 42 to provide an output signal to color LCD display 58. VESA compliant interface 42 may support Video Graphics Adapter (VGA) compliant resolutions and beyond and other flat panel display technologies such as active matrix liquid-crystal display (AMLCD), double-layer supertwist nematic (DSTN) or Plasma, and may further incorporate a Transition Minimized Differential Signaling (TMDS), “Plug & Display” coding scheme, Interface 44 may be compliant with VGA or lower resolution standards such as Enhanced Graphics Adapter (EGA), Color Graphics Adapter (CGA), or Monochrome Display Adapter (MDA) resolutions. The signal provided from video controller 26 to display 54 or display 58 is preferably completely a digital signal.

Referring now to FIGS. 3B and 3C, schematic diagrams of the simple differential interfaces shown in FIG. 3A will be discussed. As shown in FIG. 3B, differential interface 44 comprises buffer gates 62 for receiving component video control and data signals from video controller 26, each gate 62 receiving a corresponding component video signal. The component signals provided to differential interface 44 include a vertical synchronization signal (“VERT SYNC”), a horizontal synchronization signal (“HORZ SYNC”), a pixel data signal (“PIXEL DATA”), and a pixel clock signal (“PIXEL CLK”). Further, a mode select signal (“MODE SELECT”) is provide to an enable input (“ENABLE”) of differential interface 44 for controlling the utilization of differential interface 44. Likewise, differential interface 52 of monitor 48 comprises buffer gates 64 for receiving component video control and data signals from differential interface 44 via interconnect cabling 46, each gate 62 receiving a corresponding component video signal. The corresponding component video signals are provided from differential interface 52 to LCD 54 for reproducing the video signal on monitor 48. The configuration of differential interfaces 44 and 52 provide low voltage differential signaling (LVDS) that is suitable for transferring data at a higher speed and at a lower power data from computer system 10 to monitor 48. Such a configuration may be utilized, for example, for higher speed transmission (e.g., 20 MHz or greater) of transistor-transistor logic (TTL) signals provided by video controller 26 over longer distances (e.g., at least greater than 1 meter and typically 10 meters or greater) and then converting the signals back into TTL signals that are interpretable by LCD 54. A similar configuration, configured in compliance with a VESA standard such as TMDS, may also be utilized for interfaces 42 and 56.

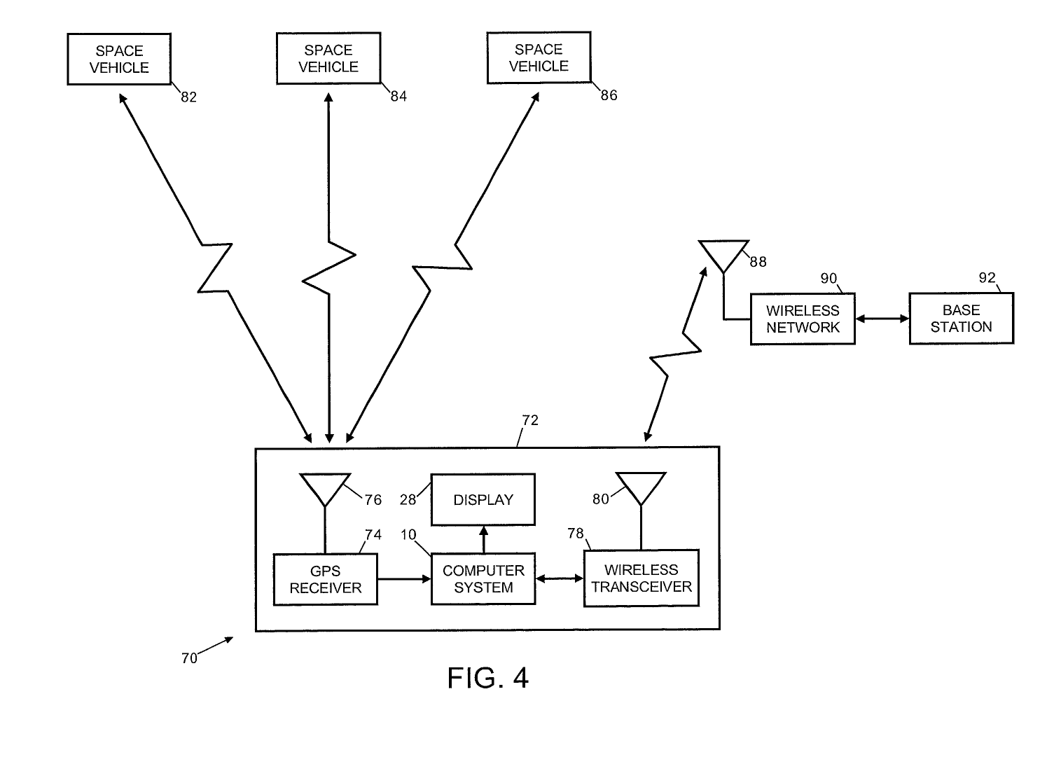

Referring now to FIG. 4, a block diagram of a transit system in which the dual mode digital display interface of the present invention may be utilized will be discussed. The transit system 70 includes a transit vehicle 72 for transporting goods or passengers. Transit vehicle includes an on-board computer system 10 coupled to display 28. Computer system 10 is coupled with a global positioning system (GPS) receiver 74 and antenna 76 for receiving a positioning and timing reference signal from a constellation of satellites 82, 84 and 86 in orbit around the earth. Such a global positioning system may be the NavStar GPS system maintained by the U.S. Government, for example. An operator of transit vehicle may be informed of the coordinate position of transit vehicle 72 and whether transit vehicle 72 is on schedule. Such information may be displayed on display 28 by computer system 10. Furthermore, computer system 10 may be coupled with a wireless transceiver 78 and antenna 80 for communicating over a wireless network 90 and appropriate antenna system 88 such that information and data may be exchanged between computer system 10 via wireless network 90. Wireless receiver 78 and GPS receiver 74 may couple with computer system 10 via peripheral bus 32 of FIG. 1. Base station 92 may transfer route and scheduling information for transit vehicle 72 to computer system 10 that is displayed on display 28 and viewed by the operator of transit vehicle 72. The route and scheduling information may be coordinated with the positioning and timing information received by computer system 10 from GPS receiver 74. When computer system 10 implements the dual mode digital video interface discussed with respect to FIGS. 2 and 3, display 28 may be freely changed from a first display type (e.g., monochrome LCD) to a second display type without requiring any modification of computer system 10 or installation of additional hardware or software, thereby allowing flexibility in the choice and cost of transit system 70.

It is believed that the dual mode digital video interface of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A dual mode digital video interface for coupling a flat panel display to a computer system, comprising:
a video controller, disposed in the computer system, for generating a video signal to be displayed on the flat panel display;
a first interface for operatively coupling said video controller to the flat panel display in a first display mode when the flat panel display is a first type of display; and
a second interface for operatively coupling said video controller to the flat panel display in a second display mode when the flat panel display is a second type of display, said first interface being enabled when the first type of display is coupled to the computer system and said second interface being enabled when the second type of display is coupled to the computer system.

2. A dual mode digital video interface as claimed in claim 1, said first interface being a lower resolution interface for coupling to a lower resolution display, and said second interface being a higher resolution interface for coupling to a higher resolution display.

3. A dual mode digital video interface as claimed in claim 1, said first interface being a monochrome interface for coupling to a monochrome display, and said second interface being a color interface for coupling to a color display.

4. A dual mode digital video interface as claimed in claim 1, said first interface being a non-multiplexing interface for coupling to a non-multiplexing display, and said second interface being a multiplexing interface for coupling to a multiplexing display.

5. A dual mode digital video interface as claimed in claim 1, said first interface being a simple differential interface for coupling to a monochrome display, and said second interface being a VESA compliant interface for coupling to a color display.

6. A dual mode digital video interface as claimed in claim 1, said first type of display being a monochrome LCD display and said second type of display being a color LCD display.

7. A digital video interface as claimed in claim 1, said first and second interfaces being implemented on a single integrated circuit.

8. A dual mode digital video interface for coupling a flat panel display to a computer system, comprising:
means, disposed in the computer system, for generating a video signal to be displayed on the flat panel display;
first interfacing means for operatively coupling said video controller to the flat panel display in a first display mode when the flat panel display is a first type of display; and
second interfacing means for operatively coupling said video controller to the flat panel display in a second display mode when the flat panel display is a second type of display, said first interfacing means being enabled when the first type of display is coupled to the computer system and said second interfacing means being enabled when the second type of display is coupled to the computer system.

9. A dual mode digital video interface as claimed in claim 8, said first interfacing means being a lower resolution interface for coupling to a lower resolution display, and said second interfacing means being a higher resolution interface for coupling to a higher resolution display.

10. A dual mode digital video interface as claimed in claim 8, said first interfacing means being a monochrome interface for coupling to a monochrome display, and said second interfacing means being a color interface for coupling to a color display.

11. A dual mode digital video interface as claimed in claim 8, said first interfacing means being a non-multiplexing interface for coupling to a non-multiplexing display, and said second interfacing means being a multiplexing interface for coupling to a multiplexing display.

12. A dual mode digital video interface as claimed in claim 8, said first interfacing means being a simple differential interface for coupling to a monochrome display, and said second interfacing means being a VESA compliant interface for coupling to a color display.

13. A dual mode digital video interface as claimed in claim 8, said first type of display being a monochrome LCD display and said second type of display being a color LCD display.

14. A digital video interface as claimed in claim 8, said first and second interfacing means being implemented on a single integrated circuit.

15. A navigation system for a transit vehicle, comprising:
a computer system, disposed in the transit vehicle, for controlling the navigation of the transit vehicle;
a global positioning system receiver, coupled to said computer system, for receiving a positioning and timing reference from a constellation of space vehicles in a global positioning system;
a display, coupled to said computer system, for displaying positioning and timing information of the transit vehicle; and
a dual mode digital video interface, operatively disposed in said computer system, for providing a first digital interface in a first mode for controlling said display when said display is a first type of display, and for providing a second digital interface in a second mode for controlling said display when said display is a second type of display.

16. A navigation system as claimed in claim 15, further comprising a transceiver, coupled to said computer system, for communicating with a remote base station over a network for transferring route and schedule information coordinated with the positioning and timing reference from said global positioning system receiver, the coordinated information being capable of being displayed on said display.

17. A navigation system as claimed in claim 15, the first digital interface of said dual mode digital video interface being a simple differential interface and the second interface of said dual mode digital video interface being in compliance with a VESA standard.

18. A navigation system as claimed in claim 15, the first digital interface of said dual mode digital video interface being enabled when said display is a monochrome display, and the second digital interface of said dual mode digital video interface being enabled when said display is a color display.

19. A navigation system as claimed in claim 15, the first digital interface of said dual mode digital video interface utilizing non-multiplexed video signals and the second digital interface of said dual mode digital video interface utilizing multiplexed video signals.

20. A navigation system as claimed in claim 15, the first digital interface of said dual mode digital video interface being a higher resolution video interface and the second digital interface of said dual mode digital video interface being a lower resolution video interface.
